(19) United States
(12) Patent Application Publication
(10) Pub. No.: US 2007/0142544 A1
(43) Pub. Date: Jun. 21, 2007

(54) High performance polyurethane carpet backings containing modified vegetable oil polyols

(76) Inventors: Randall C. Jenkines, Dalton, GA (US); Larry W. Mobley, Cohutta, GA (US); William A. Koonce, Pearland, TX (US)

Correspondence Address: THE DOW CHEMICAL COMPANY, INTELLECTUAL PROPERTY SECTION,, P. O. BOX 1967, MIDLAND, MI, 48641-1967, US

(21) Appl. No.: 10/560,341

(22) PCT Filed: May 28, 2004
(86) PCT No.: PCT/US04/16981

§ 371 Date: May 30, 2006

Related U.S. Application Data
(63) Continuation of application No. 60/478,681, filed on Jun. 13, 2003.

(51) Int. Cl. C08G 18/08

(52) U.S. Cl. 524/589

(57) ABSTRACT

Carpet backing for residential, commercial and recreational carpet which exhibits a tuftbind greater than 4.5 kg, ASTM D 1335, contains a polyurethane reaction product of a polyisocyanate; an active hydrogen containing compound; and a polyol reaction product. Typically, the polyol reaction product is a reaction product of a polyol and a vegetable oil and contains less than about 50 percent by weight of unreacted vegetable oil. The vegetable oil is preferably selected from palm oil, safflower oil, canola oil, soy oil, cottonseed oil and rapeseed oil. In a preferred embodiment, the vegetable oil is blown. Typically, the amount of unreacted vegetable oil in the polyol reaction product is less than about 34 weight percent. The hard segment of the resulting polyurethane reaction product constitutes at least 20 weight percent of the polyurethane reaction product. The carpet backing of the invention may be used as a precoat, a laminate or foam coating.

### FIELD OF THE INVENTION

The invention relates to high performance carpet backings of polyurethane reaction products which exhibit a tuftbind greater than 4.5 kg, ASTM D 1335. The polyurethane reaction product is derived from a polyisocyanate, an active hydrogen containing compound and a polyol reaction product of a polyol and vegetable oil wherein the amount of vegetable oil in the polyol reaction product which does not react with the polyisocyanate is less than or equal to 50 percent by weight.

### BACKGROUND OF THE INVENTION

Generally, tufted carpets minimally consist of tufted fibers through a primary backing and a precoat. Tufted carpets may also have additional layers such as a laminate layer, a secondary layer, and a foam layer. Moreover, the tufted carpet may have more than one secondary layer.

The precoat, the first coating applied to the carpet, is required to anchor the carpet tufts to the primary backing. Thus, the purpose of the precoat in a carpet backing is to provide fiber lock strength properties like pilling and fuzzing resistance, tuftbind and edge ravel, flame retardancy, dimensional stability, antimicrobial/antifungal activity and liquid barrier functionality. It may also contain an adhesive to adhere the tufted carpet to additional layers or the subfloor. Alternatively, a laminate layer may be applied without a precoat. However, better anchoring is achieved when a precoat is also applied than when a laminate layer is applied alone.

Since 1981, polyurethane precoats have been developed and commercialized for use in unitary, attached cushion and laminate carpet backing systems. Precoat, laminate, and foam layers are often prepared from a polyurethane material. Such polyurethane layers are typically prepared from an isocyanate formulation (A-side formulation) and a polyol formulation (B-side formulation) at the carpet manufacturing site. This is sometimes referred to as “A+B chemistry”. The use of natural oil based polyols to make polyurethane polymers has been known for over 60 years. Preparing a polyurethane layer by A+B chemistry requires a substantial investment in specialized equipment to achieve the exceptional performance characteristics of this method.

Alternatively, the polyurethane layer may be applied as an aqueous polyurethane (PU) dispersion. Aqueous PU dispersions can be prepared by polymerizing the polyurethane reactants in an organic solvent followed by dispersion of the resulting solution in water, and optionally followed by removal of organic solvent. See U.S. Pat. Nos. 3,437,624; 4,092,286; 4,237,264; 4,742,095; 4,857,565; 4,879,322; 5,037,864; and 5,221,710, which are incorporated herein by reference. Also, an aqueous polyurethane dispersion may be prepared by first forming a prepolymer, next dispersing the prepolymer in water, and finally conducting a chain extension in the water as disclosed in WO 98/41552, published Sep. 24, 1998, which is incorporated herein by reference. In this instance, the aqueous polyurethane dispersion will preferably have water as a continuous phase. U.S. Pat. No. 4,296,159 to Jenkines, et al., discloses preparing a tufted or woven article having a unitary backing prepared by applying a polyurethane forming composition to the underside of the tufted or woven article.

As a polyurethane forming composition, the polyurethane layer may be applied as a blown formulation. The blown formulation is generally prepared by mixing the A-side components with the B-side components in the presence of a gas, which is either mechanically introduced or chemically produced, to form bubbles that yield a cell-like structure in the cured polyurethane. Mechanical whipping of gas into a polyurethane formulation is also termed “frothing.”

Historically, the polyols used to produce polyurethanes are derived from ethylene oxide or propylene oxide. Typically, such polyols are either polyester polyols or polyether polyols. Such polyols have severe disadvantages. For instance, since they are derived from petroleum, they are a non-renewable natural resource. Production of polyols require large volumes of energy. Since their production is dependent on the oil business, their price tends to be unpredictable as it fluctuates with the price of petroleum. In light of the high costs to produce such polyols, alternatives have been sought.

One such alternative is the use of vegetable oils as the source of polyol. One of the difficulties in using vegetable oils is attributable to the inability to regulate the functionality of the polymer due to the amount of unreacted vegetable oil. As a result, resulting polyurethane products are unable to meet the relatively strict specifications demanded by the industry. An approach to remedy this defect was recently presented in US 2002/0121328 A1, 2002/0119321 A1 and 2002/0090488 A1. Each of these references disclose carpet materials derived from vegetable oil reaction products. Unfortunately, the tuftbind of such products is unacceptable and fails industry standards.

Accordingly, it is desirable to produce a carpet backing derived from a vegetable oil and having a tuftbind acceptable to industry standards. The carpet backing of the invention exhibits a tuftbind greater than 4.5 kg, ASTM D 1335.

### SUMMARY OF THE INVENTION

Carpet backing for residential, commercial and recreational carpet which exhibits a tuftbind greater than 4.5 kg, ASTM D 1335, contains a polyurethane reaction product of a polyisocyanate, an active hydrogen containing compound and a polyol reaction product. The polyol reaction product is a reaction product of a polyol and a vegetable oil. The amount of unreacted vegetable oil in the polyol reaction product is less than or equal to 50 weight percent (based on the total weight percent of the polyol reaction product). (As used herein, the term “unreacted vegetable oil” refers to that portion of the vegetable oil in the polyol reaction product that does not react with the polyisocyanate.) The vegetable oil is preferably selected from palm oil, safflower oil, canola oil, soy oil, cottonseed oil and rapeseed oil. In a preferred embodiment, the vegetable oil is blown.

In a preferred embodiment, the hard segment of the resulting polyurethane constitutes at least 20 weight percent of the polyurethane.

The carpet backing of the invention may be used as a precoat, a laminate or foam coating.

### DETAILED DESCRIPTION OF THE PREFERRED EMBODIMENTS

The high performance polyurethane carpet backings of the invention are derived from an active hydrogen containing compound, a polyol reaction product and a polyisocyanate. The polyol reaction product comprises no greater than 50 weight percent unreacted vegetable oil. The polyurethane carpet backings of the invention exhibit a tuftbind, ASTM D 1335, greater than 4.5, preferably greater than 5.0, most preferably 6.8, more preferably 9.0 kg.

The polyurethane carpet backings of the invention further exhibit excellent fiber strength properties like pilling and fuzzing resistance (3+rating) and edge ravel (>0.9 kg.). Other properties attributed to performance carpet backings include flexibility (<13.6 kg, hand punch), flame retardancy (>0.45 watts/cm²), dimensional stability (<0.4 percent), antimicrobial/antifungal activity (>2 mm growth free zone with 100 percent contact inhibition), low 24-hour total volatile organic components (TVOC) (<500 ug/m²-hr), liquid barrier functionality (British spill passage), and excellent castor chair resistance to backing delamination and zippering (>25000 cycles).

The polyurethane reaction product of the carpet backings of the invention are the reaction product of an A-side and a B-side. The A-side reactant comprises an isocyanate and the B side the polyol reaction product and active hydrogen containing material. Optional chain extender(s), crosslinking agent(s), catalyst(s) and other additive(s) may further be included as part of the B side reactant or may be independently introduced through a separate port(s). The other additives may include surfactants, blowing agents, frothing agents, fire retardant, pigments, antistatic agents, reinforcing fibers, antioxidants, preservatives, acid scavengers, and the like.

The carpet backings of the invention have particular applicability in the residential and commercial carpet industry as well as in carpeting for recreational use, such as boats, cars, patios, etc.

The polyol reaction product of the B side is a transesterified product of a multifunctional alcohol or a multifunctional compound (“first polyol”) and a vegetable oil. Exemplary as the first polyol is glycerin, a monosaccharide, disaccharide and polysaccharide. The functionality of such modified vegetable oils is substantially regulated and, thus, are more desirable to the industry than prior art vegetable based polyols whose functionality often differed in light of genetic or environmental reasons. The polyol reaction product contains no greater than 50 parts by weight (based on 100 parts by weight of the polyol reaction product) of unreacted vegetable oil. Use of quantities of the unreacted vegetable oil greater than 50 parts by weight of the polyol reaction product exemplifies deficiencies in such carpet backing strength properties like tuftbind and edge ravel, volatile organic chemicals, and poor cure properties.

The vegetable oil, reacted with the polyol to form the polyol reaction product, includes, but shall not be limited to, palm oil, safflower oil, sunflower oil, canola oil, rapeseed oil, cottonseed oil, linseed, and coconut oil. When these vegetable oils are used, they are preferably blown. Blown vegetable oils typically contain a hydroxyl value of about 100 to about 180 and more typically about 160, while unblown vegetable oil typically has a hydroxyl value of from about 30 to about 40. However, the vegetable oils may be crude vegetable oils or crude vegetable oils that have had the soap stock and wax compound in the crude oil removed.

The polyol reaction product may be produced in a manner similar to that for the modified vegetable oils disclosed in U.S. Patent Application Publication No. 2002/0090488 A1, herein incorporated by reference, except that the amount of unreacted vegetable oil in the polyol reaction product is not greater than 50 parts (per 100 parts of polyol reaction product). In a preferred embodiment, the amount of unreacted vegetable oil in the polyol reaction product is less than about 34 weight percent, preferably no greater than 25 weight percent. Exemplary as the first step in the two-stage transesterification process, glycerin as the first polyol is heated to about 230° F., and advantageously stirred. In the second step, a component having at least two hydroxyl groups preferably including a saccharide compound, typically a monosaccharide, disaccharide, a polysaccharide, sugar alcohol, cane sugar, honey, or mixture thereof is slowly introduced into the glycerin until saturated. This serves to increase the hydroxyl functionality. Preferred saccharide components are fructose and cane sugar. Preferably, 2 parts of the saccharide compound is added to 1 part of the multifunctional alcohol, by weight. Glycerin is a carrier for the saccharide compound component, although it does add some functional hydroxyl groups. The saccharide component is slowly added until no additional saccharide component can be added to the glycerin solution. It is believed that the multifunctional alcohol and the saccharide component undergo an initial transesterification to form new ester products (precursors). As such, the functionality of the new polyol is selectable. The greater the functionality of the alcohol, the greater the functionality of the final new polyol. Next, from about 200 to 300 grams of vegetable oil is heated to at least about 180° F. and the vegetable oil slowly reacts with the heated glycerin/saccharide ester, the first transesterification reaction product. (A transesterification catalyst such as tetra-2-ethylhexyl titanate, which is marketed by DuPont as Tyzor® TOT, may be used, instead of or in addition to heat. Also, known acids and other transesterification catalysts known to those of ordinary skill may also be used.) The vegetable oil and the first transesterification product may then undergo a second transesterification reaction that increases the functionality of the resulting polyol. Lowering the amount of the saccharide component added to the vegetable oil lowers the number of functional groups available to be cross-linked with an isocyanate group when the polyol reaction product is used to create the polyurethane. In this manner, functionality of the final polyol produced by the transesterification process of the present invention may be regulated and engineered. Therefore, more rigid urethane products are formed using by the increased amount of saccharide component. In addition, the higher functionality of the multifunctional alcohol may also increase the functionality of the urethane products formed using the new polyol.

In a preferred mode, the polyol reaction product is derived from up to about 20 parts by weight of a polyol having a weight average molecular weight less than 800. Preferred as the polyol having a weight average molecular weight less than 800 is sucrose, glycerin, dipropylene glycol as well as a blend thereof.

A polyol reaction product may further be prepared by propoxylation, butyoxylation, or ethoxylation of the vegetable oil. Thus, the addition of propylene oxide (propoxylation), ethylene oxide (ethoxylation), butylene oxide, (butyloxylation), or any other known alkene oxide to a vegetable oil, a crude vegetable oil, a blown vegetable oil, or the reaction product of the saccharide (multifunctional compound) and the multifunctional alcohol, or the final vegetable oil based, transesterified polyol produced according to the transesterification process discussed above will further increase the functionality of the polyol thereby formed and be suitable as the polyol reaction product in the invention.

The active hydrogen containing compound is a compound having a functional group that contains at least one hydrogen atom bonded directly to an electronegative atom such as nitrogen, oxygen or sulfur. Various types of active hydrogen compounds, such as amines, alcohols, polyether polyols, polyester polyols and mercaptans, for example, are known to those skilled in the art of preparing polyurethane polymers. Active hydrogen compounds suitable for use in the practice of the present invention can be polyols having molecular weights of less than about 10,000 including those end capped with a primary hydroxyl. Exemplary of active hydrogen compounds are polyether polyols, polyester polyols, and polyurea polyols. The polyester polyols include those generally derived from propylene or ethylene oxides. For flexible foams, polyester or polyether polyols with molecular weights greater than 2,500, are generally used. For semi-rigid foams, polyester or polyether polyols with molecular weights of 2,000 to 6,000 are generally used, while for rigid foams, shorter chain polyols with molecular weights of 200 to 4,000 are generally used. Generally, higher molecular weight polyols and lower functionality polyols tend to produce more flexible foams than do lower molecular weight polyols and higher functionality polyols. The amount of such active hydrogen containing compounds in the B side is between from about 25 to about 50, preferably from about 50 to about 85 parts.

At least one catalyst may further be added to the B-side or independent port to control reaction speed and effect final product qualities. The B-side of the polyurethane reaction product may further include a cross-linking agent or a chain extender and/or blowing agent.

A blowing or frothing agent is typically used to form polyurethane foams and is added to cause gas or vapor to be evolved during the reaction. Such agents are typically introduced by mechanical introduction of a gas into a liquid to form a froth (mechanical frothing). In preparing a frothed polyurethane foam, it is preferred to mix all components and then blend the gas into the mixture, using equipment such as an Oakes or Firestone foamer. In the preparation of a froth for a carpet backing, it is not necessary to obtain a froth that is stable. In a carpet backing production process, a frothed foam typically is spread on the back of a carpet using a spreading tool, such as a blade over roll, roll or knife over bedplate. The blowing agent assists in creating the size of the void cells in the final foam, and commonly is a solvent with a relatively low boiling point or water. Examples of suitable blowing agents include: gases and/or mixtures of gases such as, for example, air, carbon dioxide, nitrogen, argon, helium, and the like; liquids such as, for example, water, volatile halogenated alkanes such as the various chlorfluoromethanes and chlorofluoroethanes. The blowing agent may include such conventional blowing agents as 134A HCFC., a hydrochlorofluorocarbon refrigerant available E.I. Dupont de Nemours Company of Wilmington, Del.; methyl isobutyl ketone (MIBK); acetone; a hydrofluorocarbon; cyclopentane; methylene chloride; hydrocarbon; azo-blowing agents such as azobis (formamide) and water or mixtures thereof. Presently, compressed gas is preferred. Another possible blowing agent is ethyl lactate, which is derived from soybean. The concentrations of other reactants may be adjusted to accommodate the specific blowing agent used in the reaction.

The optional chain extender or crosslinker may be used herein to build strength properties in the polyurethane polymer. Generally, a chain extender is employed in an amount sufficient to react with from about zero (0) to about 70 percent of the isocyanate functionality present in the prepolymer, based on one equivalent of isocyanate reacting with one equivalent of chain extender. A catalyst can optionally be used to promote the reaction between a chain extender and an isocyanate.

A suitable chain extender or crosslinker is typically a low equivalent weight active hydrogen containing compound having about 2 or more active hydrogen groups per molecule. Typically, the molecular weight of the chain extender or crosslinker is less than 300. Chain extenders typically have 2 active hydrogen groups while crosslinkers have 3 or more active hydrogen groups. The active hydrogen groups can be hydroxyl, mercaptyl, or amino groups. Preferred as chain extender are ethylene glycol, propylene glycol, diethylene glycol (DEG), tripropylene glycol (TPG), 1,4-butanediol and dipropylene glycol (DPG). The chain extender can further be an amine which, further, can be blocked, encapsulated, or otherwise rendered less reactive. Other materials, particularly water, can function to extend chain length and, therefore, can be chain extenders for purposes of the present invention.

The chain extender can further be selected from amines such as amine terminated polyethers such as, for example, Jeffamine D-400 from Huntsman Chemical Company, amino ethyl piperazine, 2-methyl piperazine, 1,5-diamino-3-methyl-pentane, isophorone diamine, ethylene diamine, diethylene triamine, aminoethyl ethanolamine, triethylene tetraamine, triethylene pentaamine, ethanol amine, diethanol amine, lysine in any of its stereoisomeric forms and salts thereof, hexane diamine, hydrazine and piperazine. In the practice of the present invention, the chain extender can be used as an aqueous solution; however, other diols and triols or greater functional alcohols may be used. It has been found that a mixture of tripropylene glycol and dipropylene glycol are particularly advantageous in the practice of the present invention for precoat and laminate coat applications. Diethylene glycol is the preferred chain extender for foam coats. Proper mixture of the cross-linking agents can create engineered urethane products of almost any desired structural characteristics.

Catalysts are optional in the practice,of the present invention. Catalysts suitable for use in the present invention include tertiary amines, and organometallic compounds, like compounds and mixtures thereof. For example, suitable catalysts include di-n-butyl tin bis(mercaptoacetic acid isooctyl ester), dimethyltin dilaurate, dibutyltin dilaurate, dibutyltin diacetate, dibutyltin sulfide, stannous octoate, lead octoate, ferric acetylacetonate, bismuth carboxylates, triethylenediamine, N-methyl morpholine, like compounds and mixtures thereof. An amount of catalyst is advantageously employed such that a relatively rapid cure to a tack-free state can be obtained. If an organometallic catalyst is employed, such a cure can be obtained using from about 0.01 to about 0.5 parts per 100 parts of the polyurethane-forming composition, by weight. If a tertiary amine catalyst is employed, the catalyst preferably provides a suitable cure using from about 0.01 to about 3 parts of tertiary amine catalyst per 100 parts of the polyurethane-forming composition, by weight. Both an amine type catalyst and an organometallic catalyst can be employed in combination.

Also as known in the art, when forming foam urethane products, the B-side reactant may further comprise a surfactant. Suitable surfactants useful herein can be cationic surfactants, anionic surfactants, or a non-ionic surfactants. Examples of anionic surfactants include sulfonates, carboxylates, and phosphates. Examples of cationic surfactants include quaternary amines. Examples of non-ionic surfactants include block copolymers containing ethylene oxide and silicone surfactants. Surfactants useful in the practice of the present invention can be either external surfactants or internal surfactants. External surfactants are surfactants which do not chemically react with the polymer to form a covalent bond during the preparation of the dispersion. Internal surfactants are surfactants which do become chemically reacted into the polymer during dispersion preparation. A surfactant can be included in a formulation of the present invention in an amount ranging from about 0.01 to about 20 parts per 100 parts by weight of polyurethane component. Preferably, the formulations of the present invention include polyurethane prepolymers which are not internal surfactants.

Further, silicone surfactants which function to influence liquid surface tension and thereby influence the size of the bubbles formed and ultimately the size of the hardened void cells in a final urethane foam product may be used. This can effect foam density and foam rebound (index of elasticity of foam). Also, the surfactant may function as a cell-opening agent to cause larger cells to be formed in the foam. This results in uniform foam density, increased rebound, and a softer foam.

Further, the B side may include an inorganic or organic filler such as conventional fillers like milled glass, calcium carbonate, aluminum trihydrate, carbon, aramid, silica, silica-alumina, zirconia, talc, bentonite, antimony trioxide, kaolin, fly ash, boron nitride, with glass fibers, or other known fillers. In the practice of the present invention, a suitable filler loading in a polyurethane dispersion can be from about 100 to about 1000 parts of filler per 100 parts of polyurethane. Preferably, filler can be loaded in an amount of at least about 400 pph, more preferably at least about 300 pph, most preferably at least from about 150 to about 200 pph.

The polyisocyanate component of the formulations of the present invention can be prepared using any organic polyisocyanate, modified polyisocyanate, isocyanate-based prepolymer and mixtures thereof. These can include aliphatic and cycloaliphatic isocyanates as well as aromatic isocyanates. Suitable isocyanates include 2,4- and 2,6-toluenediisocyanate and the corresponding isomeric mixtures; 4,4′-,2,4′- and 2,2′-diphenyl-methanediisocyanate (MDI) and the corresponding isomeric mixtures; mixtures of 4,4′-, 2,4′- and 2,2′-diphenylmethanediisocyanates and polyphenyl polymethylene polyisocyanates PMDI; and modified diphenylmethane diisocyanates. Mixtures of PMDI and MDI are preferred. Most preferably, the polyisocyanate used to prepare the prepolymer formulation of the present invention is MDI prepolymers and PMDI.

Further suitable as isocyanates are prepolymer isocyanate. The prepolymer isocyanate is the reaction product of an isocyanate, preferably a diisocyanate, and most preferably some form of diphenylmethane diisocyanate (MDI) and a polyol. The polyol may be a vegetable oil such as any of those vegetables discussed herein or any other oil having a suitable number of reactive hydroxyl (OH) groups. Soy oil is particularly advantageous to use. To create the prepolymer diisocyanate, the polyol is mixed and allowed to react with the isocyanate until the reaction has ended. There may be some unreacted isocyanate (NCO) groups in the prepolymer. Alternatively, after the A-side prepolymer is formed, additional isocyanates may be added.

The hard segment content of the resulting polyurethane reaction product, which constitutes the units formed from the reaction of a diisocyanate and an active hydrogen containing material having a molecular weight less than about 800, preferably less than 400, comprises at least 20 weight percent of the polyurethane reaction product. The soft segment content of the resulting polyurethane, constitutes the units from the reaction of a dissocyanate and an active hydrogen containing material, and has a molecular weight greater than 800, more preferably greater than 1000, and most preferably greater than 1,800.

The polyurethane materials (products) of the present invention are produced by combining the A-side reactant with the B-side reactant in the same manner as is generally known in the art. Upon combination of the A and B side reactants, an exothermic reaction ensues that may reach completion in anywhere from a few seconds (approximately 2-4) to several hours or days depending on the particular reactants and concentrations used. The components may be combined in differing amounts to yield differing results, as will be shown in the Examples presented below.

The carpet backing may comprise tufts, a primary backing and a pre-coat backing. Generally, the tufts are interconnected through the primary backing, while the primary backing is generally comprised of polypropylene. The pre-coat backing is more preferably comprised of the polyurethane reaction product.

The precoat is typically the first coating applied to the carpet. The purpose of the precoat in carpet backing is to provide fiber lock strength properties like pilling and fuzzing resistance, tuftbind and edge ravel, flame retardancy, dimensional stability, antimicrobial/antifungal activity, and liquid barrier functionality.

The second coating applied to the precoat is either a laminate coating or foam coating followed by the application of a woven or non-woven secondary fabric. The precoat and either laminate or foam coating contributes to 24-hour TVOC and castor chair performance. British spill passage can be improved by applying the laminate or foam coating to the precoat.

The formulations discussed herein can be applied to a moisture resistant backing using either conventional or non-conventional methods in the art of preparing polyurethane-backed carpets. For example, a polyurethane-forming composition can be applied as a layer of preferably uniform thickness onto one surface of a carpet substrate. Polyurethane dispersions of the present invention can be applied as a precoat, laminate coat or as a foam coat.

A polyurethane-forming composition can be applied to one surface of a carpet substrate before it cures to a tack-free state. Alternatively, a polyurethane dispersion containing completely reacted isocyanate functionality can be applied to a suitable substrate, thereby removing the need to cure the polymer. Typically the polyurethane-forming composition is applied to the surface that is attached to a primary backing but can be applied to a secondary backing such as mesh or fleece. The composition can be applied using equipment such as a doctor knife, air knife, or extruder to apply and gauge the layer. Alternatively, the composition may be formed into a layer on a moving belt or other suitable apparatus and dehydrated and/or partially cured, then married to the carpet substrate using equipment such as a double belt (also known as double band) laminator or a moving belt with an applied foam cushion. The amount of polyurethane-forming composition used can vary widely, from about 5 to about 500 ounces per square yard, depending on the characteristics of the textile. After the layer is applied and gauged, water is removed from the compound using heat from any suitable heat source such as an infrared oven, a convection oven, or heating plates.

In the practice of the present invention, any of the steps used in preparing a polyurethane carpet backing can be carried out in a continuous manner. For example, in a first step the prepolymer can be prepared from a suitable active hydrogen containing compound in a continuous manner; the prepolymer can be fed, as it is obtained in the first step, into a mixing device with water to obtain an aqueous dispersion; the aqueous dispersion can be applied to a carpet substrate in a continuous manner to obtain a polyurethane backed carpet.

The following examples will illustrate the practice of the present invention in their preferred embodiments. Other embodiments within the scope of the claims herein will be apparent to one skilled in the art from consideration of the specification and practice of the invention as disclosed herein. It is intended that the specification, together with the example, be considered exemplary only, with the scope and spirit of the invention being indicated by the claims which follow.

### EXAMPLES

Unless stated otherwise, all molecular weights expressed herein are weight average molecular weight.

The following materials were employed in the Examples:

V9287A refers to VORANOL (RTM) 9287A polyol, a 2000 molecular weight 12 percent ethylene oxide capped diol stabilized with alkyldiphenylamine, a product of The Dow Chemical Company.

SoyOy1™ GC5N, a 130-hydroxyl no. 3 functional blown soy oil polyol transesterified with a blend of sucrose and glycerin to increase functionality with an unreacted vegetable oil content of 30 weight percent, a product of Urethane Soy Systems Corporation (USSC). The amount of vegetable oil in this polyol reaction product, which does not react with the polyisocyanate, is about 30 percent by weight.

T12 refers to Dabco™ T12, a dibutyltin dilaurate non-delayed action catalyst, a product of Air Product and Chemicals, Inc.

D70 refers to Georgia Marble D70, a quarried calcium carbonate ground such that 70 weight percent passes through a 325 mesh screen, a product of Georgia Marble Company.

Isonate (RTM) 7594 isocyanate is a 50/50 weight percent blend of Isonate 7500 and PAPI® 7940, a product of The Dow Chemical Company.

I7594 refers to PAPI (RTM) 7940 isocyanate is a polyphenylenepolyaromatic polyisocyanate (60 percent), having 2.3 functional, 32 weight percent isocyanate wherein pure MDI (40 percent) contains 14 weight percent 2,4′-diphenylmethane diisocyanate.

UL6 refers to Fomrez™ UL6, a dibutyltin diisooctylmercaptoacetate delayed action catalyst, a product of OSI Specialties of Crompton.

P 1200 refers to Polyglycol 1200, a 1200 molecular weight propylene oxide diol, a product of The Dow Chemical Company.

Code 5027 is an ethoxylated dodecylnol phosphate ester, a viscosity depressant, a product of Fibro Chem Inc.

I7560 refers to Isonate (RTM) 7560 isocyanate is a 60/40 weight percent blend of Isonate 7500 isocyanate and either 40 wt percent Lupranate™ MM103 isocyanate or Rubinate™ 1608 isocyanate.

Isonate (RTM) 7500 isocyanate is a dipropylene/tripropylene MDI prepolymer having 23 weight percent isocyanate, a product of The Dow Chemical Company.

Lupranate™ MM103 isocyanate is a low VOC liquefied MDI having 29.4 percent isocyanate, a product of BASF.

Rubinate™ 1608 isocyanate is a low VOC liquefied MDI having 29.4 percent isocyanate, a product of Huntsman.

### Example 1

A polyurethane reaction product was made by mixing together, in a blend tank, 4475 kg of Voranol® 9287A polyol, 384.5 kg of dipropylene glycol, 384.5 kg of tripropylene glycol, 1748 kg of SoyOy1 GC5N™, 11,189 kg of Georgia Marble D70, and 4.2 kg of Dabco™ T-12. The 160 load compound was then mixed until at a temperature of 49° C. The compound was then transferred to a run tank.

To an Oakes™ blender was metered and mixed the 160 load compound (37.6 kg/min), 7.7 kg/min Isonate® 7594 isocyanate and 0.17 kg/min 5 wt. percent UL6 in Voranol 9287 polyol. Variable levels of air were added to the Oakes in order to control coating weight. The precoat was then applied to a puddle rolling on the backside of the carpet via a traversing hose. The precoat was deposited onto the carpet style 2485 (available from J&J Industries, Inc.) using a coating knife. The carpet and applied precoat were conveyed into a gas fire oven by chain-driven tenter pins and cured at 300° C. for 4 minutes. The cure carpet precoat backing then proceeded to a second application where a mechanically frothed polyurethane cushion was applied in a similar manner. A non-woven polyester scrim (available from Western NonWovens) was laid into the froth and the composite was transported through a second curing range for a final cure. The carpet was inspected, rolled onto cores and wrapped for shipment.

The carpet was tested for performance properties. It exhibited

pilling and fuzzing resistance (4.5 rating),

tuftbind (11.1 Kg.), ASTM D 1335, and

edge ravel (1.5 Kg.). The edge ravel test was conducted using an Instron die cut three 2″×6″ carpet samples (1 each from left, right and center of carpet, cut left and right samples no closer than 1″ from the edge of the carpet). The samples were conditioned for at least 24 hours at 23° C.±3° C., 50 percent humidity, ±5 percent. The samples were prepared by pulling out two complete tuft rows. This was accomplished using needle nose pliers. Any excess primary backing, foam, or scrim was trimmed away from the third tuft row with scissors. The next tuft row approximately 1.5 to 2 inches of total yam length was pulled along the prepared length. The tension load cell (set at either 100 or 10 lbs.) was mounted and the cell allowed to warm up for 10 minutes. The pneumatic jaws on the Instron were installed. The crosshead levers were checked to insure that they were in their proper positions. The right lever should be pushed to the rear and the left lever should be pulled toward the front of the machine. The Instron was operated according to the manufacturer's instructions, setting the maximum extension at a setting of 8 and the speed at a setting of 10. The test specimen was placed in the lower jaw of the Instron with the prepared edge facing upwards. The partially unraveled tuft row was secured in the upper jaw. The test was started by pressing the “Up” button on the control panel. The results were then recorded.

Other properties measured were:
Flexibility (10.1 Kg. hand punch), The hand punch was measured as the force required to push a 9 inch by 9 inch (22.9 cm.×22.9 cm) piece of carpet 0.5 inches (1.27 cm) into a 5.5 inch (14 cm) inner diameter cylinder at a rate of 12.0 inches (30.5 cm) per minute, using a 2.25 inch (5.7 cm) outer diameter solid cylinder attached to a load cell. Flame retardancy (0.51 watts/cm²), ASTM E648-94;
24-hour TVOC (316 ug/m²-hr), Test run according to Air Quality Science standards, a castor chair resistance to backing delamination and zippering (25000 cycles), British spill passage in which 100 ml of a solution of methylene blue dye in water was poured from a height of 1 meter onto a 12×0.12 inch (30.5 cm.×30.5 cm) piece of carpet and allowed to stand for 4 hours. The sample was inscribed with a razor knife to reveal the interior. A pass rating was given if no blue dye is found to have penetrated into or through the backing.

### Examples 2-5

A unitary carpet backing sample was prepared as follows. The designated amounts of Voranol® 9287A polyol, dipropylene glycol (DPG), tripropylene glycol (TPG), SoyOyl GC5N^{M}, Georgia Marble D70, P1200, Code 5027, and Dabco™ T-12 were introduced into a 400-ml tripour plastic cup. The cup was secured and the compound was mixed using a 3 inch Cowles blade at 2000 rpm until the temperature of 49C. The composition was allowed to cool down to room temperature. The appropriate amount of Isonate® 7560 isocyanate was then added and the resulting composition was mixed at 1500 rpm while monitoring the temperature. When the mixture reached 80° F., the appropriate amount of catalysts were added, UL-6 and T-12. The composition was allowed to continue mixing for 30 seconds. After 30 seconds, mixing was terminated and a 4 inch diameter puddle was then poured out as a puddle onto a tentered target carpet style. A unitary coating was applied using a scrape down blade. The carpet was detentered and placed face down into a 130 C oven. The sample was cured for six minutes.

As set forth in Table I, there was a statistically significant correlation between SoyOyl GC5N content in the precoat and the tuftbind of the finished carpet, with lower content correlating to higher tuftbind.

TABLE I

| | Ex. 2 | Ex. 3 | Ex. 4 | Ex. 5 |
|---|---|---|---|---|
| Components | Parts | Parts | Parts | Parts |
| V9287A | 14 | 14 | 14 | 14 |
| DPG | 5.5 | 5.5 | 5.5 | 5.5 |
| TPG | 5.5 | 5.5 | 5.5 | 5.5 |
| GC5N | 0 | 25 | 50 | 75 |
| P1200 | 75 | 50 | 25 | 0 |
| Code 5027 | 1.5 | 1.5 | 1.5 | 1.5 |
| D-70 | 200 | 200 | 200 | 200 |
| I7560 | 55 | 57 | 59 | 61 |
| Isocyanate Index | 117 | 116 | 114 | 113 |
| UL-6 | 0.05 | 0.1 | 0.3 | 0.3 |
| T-12 | 0.05 | 0.1 | 0.3 | 0.3 |
| Coat Wt. (kg/m²) | 1 | 0.99 | 0.92 | 1 |
| Tuftbind (kg) | 7.9 | 5.4 | 4.6 | 4.5 |
| Tuftbind (kg) (normalized to 1 kg/m² | 7.9 | 5.5 | 5.0 | 4.5 |
| coating weight | | | | |

The tuftbind (normalized to 1 kg/m² and soybean oil content is graphically displayed in FIG. 1. FIG. 1 illustrates that more than 50 parts of soybean vegetable oil drops the tuft bind below 5 kg, ASTM D 1335.

### Examples 6-17

A unitary carpet backing sample was prepared as follows. The designated amounts of Voranol® 9287A polyol, dipropylene glycol (DPG), SoyOyl GC5N^{M} and Georgia Marble D70 were introduced into a 400-ml tripour plastic cup. The cup was secured and mixing was allowed to a temperature of 49 C. The composition was allowed to cool down to room temperature. The appropriate amount of Isonate® 7594 isocyanate was then added and the resulting composition was mixed at 1500 rpm while monitoring the temperature. When the mixture reached 80° F., the appropriate amount of catalysts were added, UL-6 and T-12. The composition was allowed to continue mixing for 30 seconds. After 30 seconds, mixing was terminated and a 4 inch diameter puddle was then poured out as a puddle onto a tentered target carpet style. A unitary coating was applied using a scrape down blade. The carpet was detentered and placed face down into a 266° F. oven. The sample was cured for six minutes.

As set forth in Table II, with the exception of Example 16, where the formulation exceeded 50 parts CG5N, the tuftbind falls below 5 kg.

TABLE II

| Components | Parts | Parts | Parts | Parts | Parts | Parts | Parts | Parts | Parts | Parts | Parts | Parts |
|---|---|---|---|---|---|---|---|---|---|---|---|---|
| V9287A | 60 | 25 | 30 | 55 | 85 | 20 | 90 | 50 | 80 | 55 | 30 | 55 |
| DPG | 10 | 15 | 10 | 15 | 15 | 20 | 10 | 20 | 20 | 15 | 10 | 15 |
| GC5N | 30 | 60 | 60 | 30 | 0 | 60 | 0 | 30 | 0 | 30 | 60 | 30 |
| D-70 | 160 | 160 | 160 | 160 | 160 | 160 | 160 | 160 | 160 | 160 | 160 | 160 |
| I7594 | 51.7 | 70.7 | 58.5 | 63.9 | 50 | 83 | 44.8 | 76.1 | 69.2 | 63.9 | 58.5 | 63.9 |
| Isocyanate | 115 | 115 | 115 | 115 | 115 | 115 | 115 | 115 | 115 | 115 | 115 | 115 |
| Index | | | | | | | | | | | | |
| UL-6 | 0.6 | 1.2 | 0.6 | 0.6 | 0.25 | 1.2 | 0.25 | 0.6 | 0.25 | 0.6 | 0.6 | 0.6 |
| T-12 | 0.6 | 1.2 | 0.6 | 0.6 | 0 | 1.2 | 0 | 0.6 | 0 | 0.6 | 0.6 | 0.6 |
| Coat Wt. | 1 | 1 | 1 | 1 | 1 | 1 | 1 | 1 | 1 | 1 | 1 | 1 |
| (kg/m²) | | | | | | | | | | | | |
| Tuftbind (kg) | 5.3 | 4.8 | 4.1 | 5.6 | 8 | 4 | 6.1 | 5.6 | 8.1 | 6.3 | 5.2 | 7.3 |

From the foregoing, it will be observed that numerous variations and modifications may be effected without departing from the true spirit and scope of the novel concepts of the invention.

What is claimed is:

1. A carpet backing of a polyurethane reaction product of:
a polyisocyanate;
an active hydrogen containing compound; and
a polyol reaction product of a first polyol and a vegetable oil, wherein the amount of unreacted vegetable oil in the polyol reaction product is less than about 50 weight percent; and
further wherein the tuftbind of the carpet backing is greater than 4.5 kg, ASTM D 1335.

2. The carpet backing of claim 1, wherein the tuftbind of the carpet backing is greater than 5.0 kg, ASTM D 1335.

3. The carpet backing of claim 2, wherein the tuftbind of the carpet backing is greater than 6.8 kg, ASTM D 1335.

4. The carpet backing of claim 3, wherein the tuftbind of the carpet backing is greater than 9.0 kg, ASTM D 1335.

5. The carpet backing of claim 1, wherein the polyol reaction product is derived from up to about 20 parts by weight of a polyol having a weight average molecular weight less than 800.

6. The carpet backing of claim 5, wherein the polyol having a weight average molecular weight less than 800 is sucrose, glycerin, dipropylene glycol and a blend thereof.

7. The carpet backing of claim 1, wherein the vegetable oil is selected from palm oil, safflower oil, canola oil, soy oil, cottonseed oil and rapeseed oil.

8. The carpet backing of claim 7, wherein the vegetable oil is soy oil.

9. The carpet backing of claim 1, wherein the vegetable oil is blown.

10. The carpet backing of claim 9, wherein the blown vegetable oil is selected from blown palm oil, blown safflower oil, blown canola oil, blown soy oil, blown cottonseed oil, and blown rapeseed oil.

11. The carpet backing of claim 10, wherein the blown vegetable oil is blown soy oil.

12. A carpet backing for use in residential or commercial carpet comprising a polyurethane reaction product of:
a polyisocyanate;
an active hydrogen containing compound; and
a polyol reaction product of a first polyol and a vegetable oil, wherein the polyol reaction product contains less than about 50 percent by weight of unreacted vegetable oil and further wherein the polyol reaction product is derived from up to about 20 parts by weight of a polyol having a weight average molecular weight less than 800; and
further wherein the tuftbind of the carpet backing is greater than 4.5 kg, ASTM D 1335.

13. The carpet backing of claim 12, wherein the tuftbind of the carpet backing is greater than 5.0 kg, ASTM D 1335.

14. The carpet backing of claim 13, wherein the, tuftbind of the carpet backing is greater than 6.8 kg, ASTM D 1335.

15. The carpet backing of claim 14, wherein the tuftbind of the carpet backing is greater than 9.0 kg, ASTM D 1335.

16. The carpet backing of claim 12, wherein the carpet backing is a precoat, a laminate or foam coating.

17. The carpet backing of claim 12, wherein the amount of unreacted vegetable oil in the polyol reaction product is less than about 34 weight percent.

18. The carpet backing of claim 12, wherein the vegetable oil is selected from palm oil, safflower oil, canola oil, soy oil, cottonseed oil and rapeseed oil.

19. The carpet backing of claim 18, wherein the vegetable oil is soy oil.

20. The carpet backing of claim 18, wherein the vegetable oil is blown.

21. The carpet backing of claim 12, further comprising up to about 200 parts by weight of a filler.

22. A residential or commercial carpet containing the carpet backing of claim 1.

23. A residential or commercial carpet containing the carpet backing of claim 12.
